(19) United States
(12) Patent Application Publication
(10) Pub. No.: US 2018/0161976 A1
(43) Pub. Date: Jun. 14, 2018

(54) APPARATUS FOR SECURING TOOLS, PARTS, AND THINGS WHILE PERFORMING MAINTENANCE BENEATH THE HOOD OF A VEHICLE OR BENEATH THE CHASSIS OF A VEHICLE

(71) Applicant: Michael Kicsak, Johnson City, NY (US)

(72) Inventor: Michael Kicsak, Johnson City, NY (US)

(21) Appl. No.: 15/372,673

(22) Filed: Dec. 8, 2016

(51) Int. Cl. B25H 5/00; B62B 3/02; B62B 3/10

(52) U.S. Cl. CPC B25H 5/00; B62B 3/02; B62B 2202/48; B62B 2206/02; B62B 3/10

(57) ABSTRACT

An apparatus for securing tools, parts, and things while a person performs maintenance beneath the hood of a vehicle or beneath the chassis of a vehicle. The apparatus is able to be secured to the underside of a vehicle's hood and tools and other objects may be secured thereto by magnets or other means while a person performs maintenance. Removable wheels may be affixed to the apparatus or the apparatus may include permanent wheels to enable a person performing maintenance beneath a vehicle to conveniently maneuver the apparatus and attached tools and parts to where the person is working. In addition, the apparatus may include a means for providing light to illuminate the workspace or part of the vehicle on which the user is performing maintenance.

The terms “automobile” and “vehicle” are used interchangeably herein.

As used herein, the term “secured” when referring to “securing” objects to the apparatus should be construed to include any way by which a tool, part, or other thing may be connected (whether directly or indirectly) to the apparatus. For example, hooks are discussed herein as one means by which tools or parts may be secured to the apparatus. While using hooks would technically result in a user “hanging” tools or parts from the apparatus, such an act of “hanging” tools or parts from the apparatus is referred to herein as “securing” tools or parts to the apparatus.

### BACKGROUND OF THE INVENTION

Automobiles of all kinds require regular maintenance. Due to the complex nature of automobiles, mechanics (whether professionals or persons performing maintenance at home on their personal vehicles) often must use several different tools when performing automobile maintenance. In addition, automobile maintenance often requires replacing vehicle parts, which vary in size from large to very small.

Because numerous tools and parts are needed while performing automobile maintenance, mechanics are in need of a way to reliably secure tools and parts so that the tools and parts remain conveniently close while the mechanic is working on the vehicle. The need to reliably secure tools and parts is exacerbated by the fact that resting tools or parts on vehicles or engine compartments, which are often uneven and irregularly shaped, can result in the tools or parts falling to inaccessible locations within the vehicle or engine compartment if the tools or parts are even slightly nudged (this causes an additional problem because tools and parts may break if they fall). Furthermore, persons performing maintenance on a vehicle often refer to instructional manuals and similar resources to ensure they are performing the maintenance properly. If an instruction manual is simply resting on a vehicle or engine compartment and the person performing maintenance will be unable to continue the maintenance work until the manual is retrieved. This loss of tools, parts, instructional manuals, and other things needed to perform vehicle maintenance is problematic for the mechanic in that it hampers maintenance and increases expense (as lost or broken tools and parts must be replaced), and it can also cause damage to a vehicle if a tool, part, piece of a manual, or other maintenance item is lost within a vehicle's engine compartment and disrupts the engine's operation.

Mechanics also at times need a way to illuminate the parts of automobiles on which they are performing maintenance. Further, mechanics frequently perform maintenance under the hood of the vehicle and beneath the vehicle's chassis. As such, it would be desirable for mechanics to have a single device that is capable of securing tools and parts when a mechanic is working beneath a vehicle's hood or when a mechanic is working beneath a vehicle's chassis. It would be further desirable if the single device that is capable of securing tools while a mechanic works under the hood or beneath the chassis is also capable of providing light so that the mechanic can (if necessary) better see the vehicle parts on which he or she is working.

Although prior art exists that discloses inventions that are useful for securing tools and providing light while a person performs maintenance either under a vehicle's hood or beneath a vehicle's chassis (see U.S. Pat. Nos. 4,488,497; 4,715,573; 6,520,092, and 8,646,622), no such prior art discloses an invention for securing tools and providing light that may be secured to a vehicle hood and used beneath the vehicle's chassis. In addition, where several inventions disclosed in the prior art may not be stored within the vehicle due to their size and design, the invention disclosed herein can easily be kept in a vehicle (whether in the trunk or in the vehicle's passenger cabin) so that the invention may be used if maintenance must be performed on a vehicle on the roadside or in any other location apart from a garage or vehicle owner's home. The ability to store the invention disclosed herein within a vehicle at all times therefore increases the utility of the invention and distinguishes the invention from prior art.

### SUMMARY OF THE INVENTION

The present invention provides an apparatus that is capable of securing tools, parts, and things, and providing light, while a mechanic works under the hood of an automobile or beneath the chassis of an automobile.

### BRIEF DESCRIPTION OF THE DRAWINGS

The drawings included herewith are not intended to in any way limit the scope of the invention disclosed herein. The drawings are merely included to clarify and exemplify the invention as disclosed and claimed herein.

FIG. 1 is an underside view of the invention that includes interior lighting means.

FIG. 2 is a view of the invention attached horizontally to the underside of a vehicle's hood and with the invention including lighting means that are powered by the vehicle's battery.

FIG. 2a shows how hooks that may be included as part of the invention may be used to secure the invention to a vehicle's hood.

FIG. 3 is a view of the invention attached to the underside of a vehicle's hood, spanning the length of the hood, and with the invention including lighting means that are powered by the vehicle's battery.

FIG. 4 shows the invention, with wheels attached thereto, being used beneath the chassis of a vehicle.

FIGS. 5a, 5b, and 5c show how various tools and lighting means may be secured to the invention.

FIG. 6 shows an example of how the invention may be fashioned so that it elongates telescopically.

FIGS. 7a and 7b show additional examples of how the invention may be fashioned so that it may be elongated. FIG. 7a shows how the invention may be fashioned from multiple separable pieces, thereby allowing the apparatus to be elongated or shortened by adding or removing pieces. FIG. 7b shows how the invention may be layered, such that by rotating the layers the apparatus may be elongated.

FIG. 8 shows an enlarged view of the invention fashioned to include wheels and extend telescopically, as the invention might be positioned by a person working beneath the chassis of a vehicle and with tools secured to the invention.

### DETAILED DESCRIPTION OF THE INVENTION

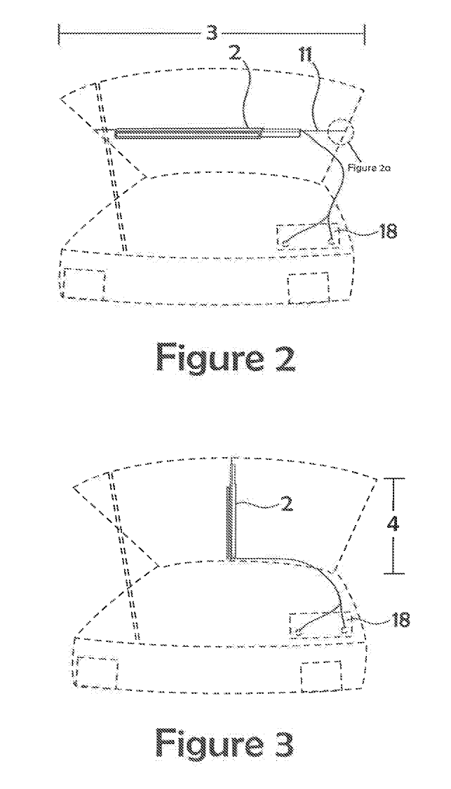

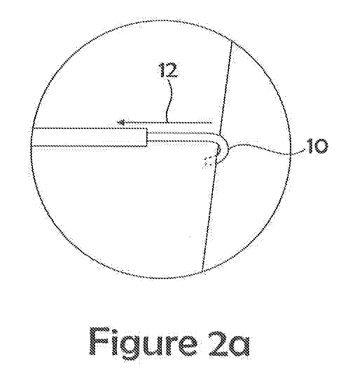

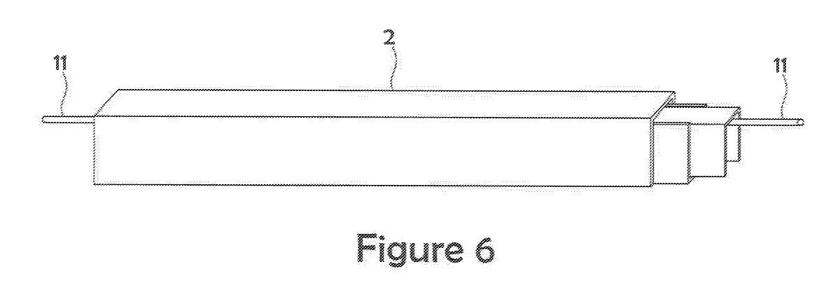

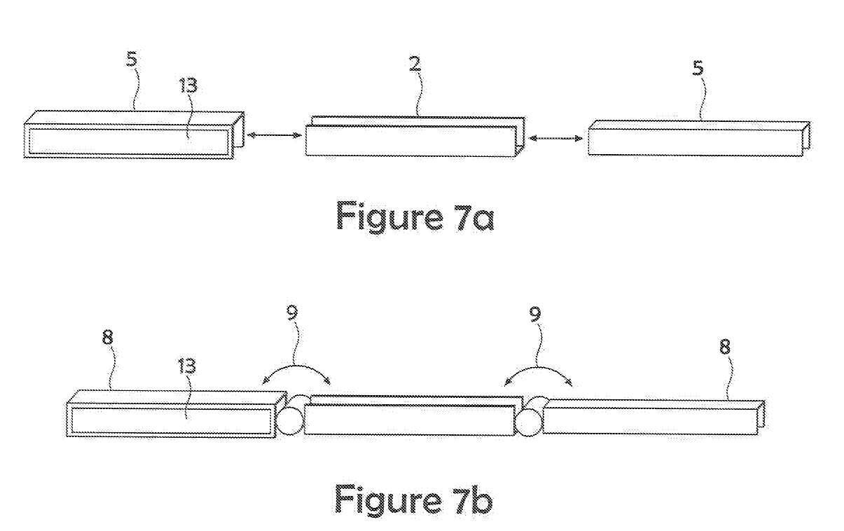

The present invention provides an apparatus that is capable of securing tools, parts, and things, and providing light, while a mechanic works under the hood of an automobile or beneath the chassis of an automobile. As shown in FIGS. 2 and 3, the apparatus 2 is comprised of an elongated body that is capable of spanning the width 3 or length 4 of a vehicle hood. In the preferred embodiment, the apparatus is able to be elongated such that the invention may be used when working on automobiles with hoods of varying sizes or so that the invention may be secured to span the width of the hood 3, the length of the hood 4, or any diagonal angle across the hood. The ability to elongate the apparatus can be achieved by many methods known in the art. For example, as shown in FIG. 6, the apparatus may be fashioned such that it elongates telescopically, thereby allowing the apparatus to be elongated. Another example, as shown in FIG. 7a, includes fashioning the apparatus from multiple separable pieces 5, thereby allowing the apparatus 2 to be elongated or shortened by adding or removing pieces 5. The apparatus may also be layered as shown in FIG. 7b, such that by rotating the layers 8 the along the path of the arrows 9, the apparatus may be elongated. However, these examples are illustrative only. It will be apparent to those skilled in the art that there are other methods of building or assembling the apparatus that will also permit the apparatus to be elongated. The invention disclosed herein includes all means of elongating the apparatus that are known to persons having ordinary skill in the art.

### Attaching the Apparatus to the Hood

The present invention includes a means by which the apparatus may be secured to the underside or topside of an automobile's hood. While the invention disclosed herein is capable of being secured to the topside of a vehicle's hood and such securing of the invention to the topside of a vehicle hood is considered within the scope of the invention disclosed herein, the preferred use of the invention is such that the elongated body portion of the apparatus is situated beneath the vehicle's hood. As such, most discussion herein focuses using the invention with the elongated body beneath or on the “underside” of a vehicle's hood. Securing the apparatus to the underside of the automobile's hood accomplishes the dual goals of: (i) permitting tools and parts secured to the apparatus to remain close to the mechanic; and (ii) illuminating the space beneath the hood (via use of the optional lighting, as explained below).

There are numerous means by which the apparatus may be secured to an automobile's hood. As shown in FIG. 2a, one means includes using hooks 10 that wrap around the edges of the automobile's hood. These hooks may be fashioned in a variety of ways. For example, the hooks may be retractably secured to the apparatus, such that the hooks may be drawn out of the apparatus until they reach a length that is appropriate to secure the apparatus to the automobile's hood. In FIG. 6, reference numbers 11 show the portion of the hook that may be drawn out of the apparatus 2 (FIG. 6 does not show the hooks, which exist on the end of the elongated portion of the hooks indicated by reference numbers 11). When the mechanic has completed maintenance on the automobile, the hooks may then be retracted to their original position. As shown in FIG. 2a, if retractable hooks 10 are included with the invention, they may optionally be secured to the apparatus using tension, such that when the hooks are withdrawn from the apparatus there is a tensile force (as shown by the arrow corresponding to reference number 12 in FIG. 2a) that “pulls” the hooks back toward the apparatus. This tensile force may result in the apparatus being better secured to the automobile's hood.

If hooks are used as part of the means to secure the apparatus to the vehicle's hood, the hooks may optionally be fashioned from pliable material. This permits a mechanic to bend the hooks around the shape of the automobile's hood, which may permit the mechanic to ensure that the hooks have a more snug fit to the hood. The hooks may also be fashioned in a variety of forms. Hooks of different sizes and forms may provide a more secure fit to hoods of different automobiles. All sizes and forms of hooks should be considered within the scope of the invention disclosed herein.

Hooks are not, however, the only means by which the apparatus may be secured to the vehicle's hood. A person having ordinary skill in the art will recognize that many alternative means may be employed to secure the apparatus to the automobile's hood. These alternative means include but are not limited to clamps, magnets, bungie cords, and fashioning the apparatus to include pegs or hooks that may be inserted into holes that may exist on the underside of many vehicle hoods (such as the hole commonly included in older-model vehicle hoods as a resting place to position the rod that is used to prop the hood open). All such alternative means, as well as all additional means of securing the apparatus to an automobile's hood that are available to a person having ordinary skill in the art, should be considered within the scope of this invention.

### Securing Tools to the Apparatus

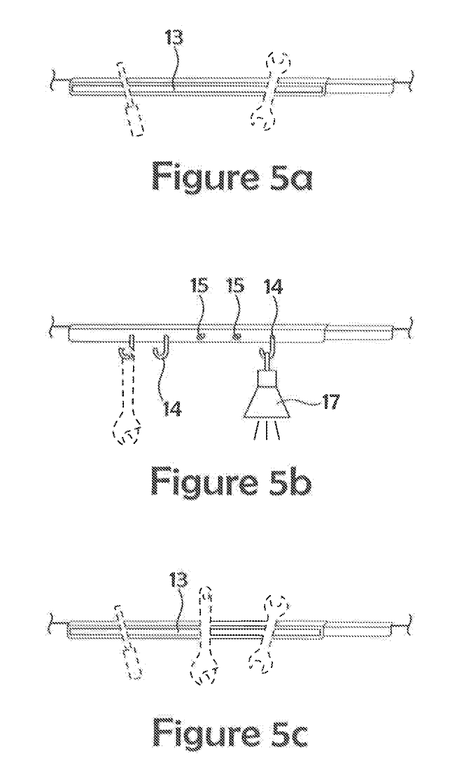

The apparatus may be adapted such that tools and parts (including large parts such as belts, hoses, and gaskets) may be secured to it. As shown in FIGS. 5a, 5b, and 5c, there are numerous means by which the apparatus may be adapted such that tools may be secured to it. One means includes using magnets 13. By including magnets 13 either within the apparatus, on the outside of the apparatus 2 (as shown in FIGS. 5a and 5c), or in any other manner, all tools and automobile parts that respond to magnets may be secured to the apparatus by putting the tool or part into contact with the apparatus 2 or the magnet 13 attached to the apparatus 2. If the apparatus 2 does include magnets, such magnets may be positioned to span the whole of the apparatus or only parts or a single part of the apparatus (such partial inclusion of magnets on the exterior of the apparatus is shown in FIGS. 5a and 5c).

Persons having ordinary skill in the art will recognize, however, that magnetics is only one of many means of securing tools or parts to the apparatus. As shown in FIG. 5b, the apparatus may also be adapted to include hooks 14 or pegs 15 to which tools or parts may be secured. Velcro is another option; by adapting the apparatus to include Velcro, any tool that contains a corresponding Velcro surface may be attached to the apparatus. Other means of adapting the apparatus such that tools may be secured to it include but are not limited to clamps. Clamps (as well as hooks 14 and pegs 15) permit the user to secure nonmetallic objects (such as an instructional manual, vehicle hoses, or tools and parts composed of plastic or fiberglass) to the apparatus. The ability to secure these types of non-metallic objects provides the user with the ability to clamp an instructional manual open while displaying the page(s) of the manual to which the user needs to refer, while also having nonmetallic tools and parts on hand to perform the maintenance. Based on market trends of using metal less frequently when producing tools and vehicle parts, the ability of the apparatus to utilize means such as hooks 14, pegs 15, or clamps will provide users with an increasingly useful apparatus to assist with the performance of vehicle maintenance.

The preferred embodiment of the invention disclosed herein includes a combination of magnet(s) 13, clamps, and/or hooks 14 or pegs 15, which allows the user to secure nonmetallic objects such as an instructional manual or hose using the clamps, while securing metallic objects such as nuts and bolts using the magnet 13. However, all means of adapting the apparatus such that tools may be secured to it that are available to a person having ordinary skill in the art, and all combinations thereof, should be considered within the scope of this invention.

### Lighting

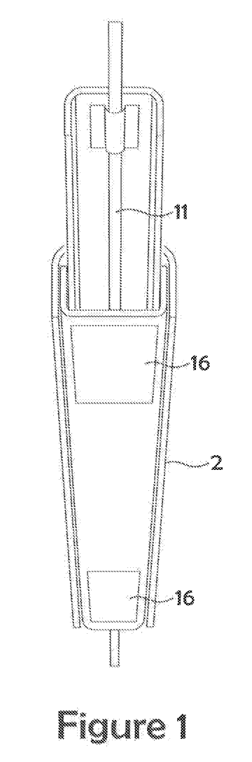

The apparatus may be adapted to include a means of providing light to assist the mechanic with the maintenance work he or she is performing. Adapting the apparatus to provide light may be accomplished by numerous means. As shown in FIG. 1, one means for including lighting involves including lights within the apparatus 2 and composing at least a portion 16 of the apparatus 2 of material that will allow the light produced from the interior lights to pass through such portion 16 of the apparatus and illuminate the mechanic's workspace. The apparatus may also be adapted to provide light by including a “snake light” (whether secured to the interior of the apparatus or exterior), or, as shown in FIG. 5b, by securing a work light 17 or other light-producing means to the outside of the apparatus. Such light producing means may be secured to the outside of the apparatus by the use of magnets or hooks (as shown in FIG. 5b); however, persons with skill in the art will recognize that these are only two of many ways to secure a light-producing means to the outside of the apparatus and all such ways known to a person of skill in the art should be considered within the scope of this invention. Persons of skill in the art will also recognize that there are numerous ways to adapt the apparatus to include lights within the apparatus such that the light produced therefrom may illuminate the mechanic's workspace, and all such ways of including lights within the apparatus should be considered within the scope of this invention.

Where the apparatus is adapted to include a means for providing light, such light-producing means may be powered in numerous ways. As shown in FIGS. 2 and 3, one way to power the light-producing means is by using the automobile's battery 18. Persons with skill in the art will recognize how to use the automobile's battery 18 to power the light producing means (such battery 18 may or may not be connected to or installed within a vehicle). Such light-producing means may also be powered by any other way of providing power known to those with skill in the art, including hut not limited to batteries, rechargeable batteries, solar technology, and using power drawn from wall outlets, USB ports inside the vehicle, any other “plug in” that is inside the vehicle, or other power sources. All methods of powering light that are known to those of skill in the art should be considered within the scope of this invention.

### Adapting the Apparatus to Receive Wheels

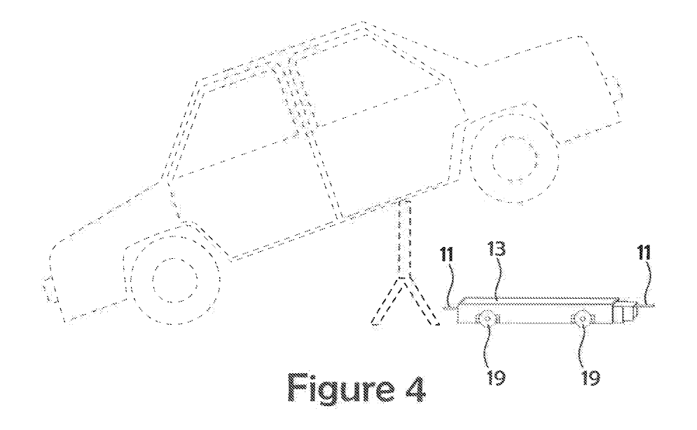

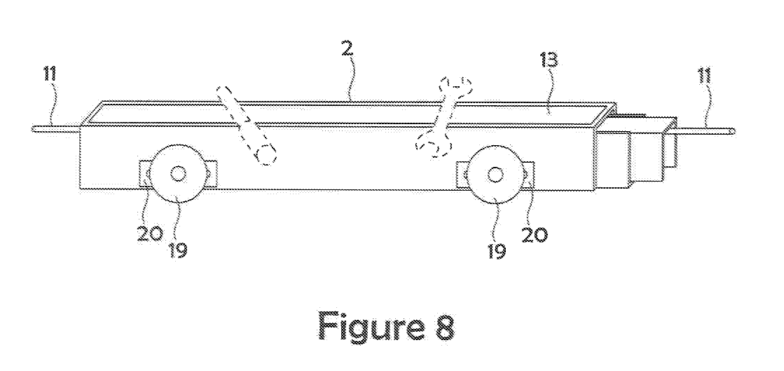

As noted above, and as shown in FIG. 4, the invention disclosed herein is capable of being used by a mechanic working under a vehicle's chassis. The apparatus may simply be placed beneath a vehicle, such that it rests in a stationary position beneath the vehicle. But while simply placing the apparatus beneath a vehicle's chassis is possible and is considered within the scope of the invention disclosed herein, that is not the preferred embodiment of the invention. Rather, as shown in FIG. 4, in the preferred embodiment, the apparatus is adapted to receive wheels 19, such that it may be wheeled beneath the chassis of a vehicle rather than simply being placed and remaining stationary beneath the chassis of a vehicle. By wheeling the apparatus beneath the vehicle, the apparatus is able to easily move as the mechanic moves, which will more easily keep tools and parts secured to the apparatus within the mechanic's reach. FIG. 8 exemplifies how tools may be secured to the apparatus 2 when being used under the chassis of a vehicle. In addition, where the apparatus includes a means for providing light, the movability that results from being able to wheel the apparatus will make it easier for a mechanic to move the apparatus and the light provided therefrom to the area under the chassis where the mechanic needs light.

There are numerous ways by which a person with skill in the art may adapt the apparatus 2 such that wheels 19 may be attached thereto. In the preferred embodiment, the apparatus receives the wheels via magnetics. Attaching the wheels to the apparatus via magnetics can be done by several means. For example, if the apparatus includes magnets as explained above, the wheels may be attached to a base that responds to magnets and attached to the apparatus via that magnetic connection. Conversely, if the apparatus 2 does not include magnets but is comprised of material that responds to magnets, the wheels 19 may be attached to a base 20 that includes magnets and attached to the apparatus 2 via that magnetic connection. The wheels could also be connected via Velcro or by using “twist lock” technology. The above means of attaching wheels to the apparatus are only exemplary. Persons having ordinary skill in the art will recognize that there exist other means of attaching wheels to the apparatus and all such means should be considered within the scope of this invention.

The wheels could also be permanently attached to the apparatus. If the wheels are permanently attached, they could be fashioned as a part of the apparatus or they could be permanently secured to the apparatus using adhesive; they could be soldered to the apparatus; they could be attached to the apparatus using screws; or the wheels could be permanently attached to the apparatus by any means known to a person having ordinary skill in the art and all such means should be considered within the scope of this invention.

What is claimed is:

1. An apparatus for securing objects, comprising:
an elongated body, wherein the elongated body includes at least one means for securing at least one object to the elongated body;
at least one means for securing the elongated body to a vehicle's hood; and
wherein the apparatus is able to receive removable wheels.

2. The object securing apparatus of claim 1, further comprising removable wheels attached to the apparatus.

3. The object securing apparatus of claim 1, wherein the apparatus includes a means for producing light.

4. The object securing apparatus of claim 1, wherein the elongated body is fashioned such that it may be elongated and subsequently shortened.

5. The object securing apparatus of claim 1, wherein the at least one means for securing at least one object to the elongated body includes magnets.

6. The object securing apparatus of claim 1, wherein the at least one means for securing at least one object to the elongated body includes clamps.

7. The object securing apparatus of claim 2, wherein the wheels are attached to the apparatus via magnets.

8. The object securing apparatus of claim 2, wherein the wheels are attached to the apparatus via Velcro.

9. The object securing apparatus of claim 3, wherein the at least one means for producing light is powered by a vehicle battery.

10. The object securing apparatus of claim 3, wherein the at least one means for producing light is powered by a wall outlet.

11. The object securing apparatus of claim 3, wherein the at least one means for producing light is powered by “plug in” ports that are part of the vehicle.

12. An apparatus for securing objects, comprising:
an elongated body, wherein the elongated body includes at least one means for securing at least one object to the elongated body;
at least one means for securing the elongated body to a vehicle's hood; and
wherein wheels are permanently affixed to the apparatus.

13. The object securing apparatus of claim 12, wherein the apparatus includes at least one means for producing light.

14. The object securing apparatus of claim 12, wherein the elongated body is fashioned such that it may be elongated and subsequently shortened.

15. The object securing apparatus of claim 12, wherein the at least one means for securing at least one object to the elongated body includes magnets.

16. The object securing apparatus of claim 12, wherein the at least one means for securing at least one object to the elongated body includes clamps.

17. The object securing apparatus of claim 13, wherein the at least one means for producing light is powered by a vehicle battery.

18. The object securing apparatus of claim 13, wherein the at least one means for producing light is powered by a wall outlet.

19. The object securing apparatus of claim 13, wherein the at least one means for producing light is powered by “plug in” ports that are part of the vehicle.
